(19) United States
(12) Patent Application Publication
(10) Pub. No.: US 2026/0050642 A1
(43) Pub. Date: Feb. 19, 2026

(54) AI IN AN ELECTRONIC APPLIANCE

(71) Applicant: Nima AHMADI, Duisburg (DE)

(72) Inventor: Nima AHMADI, Duisburg (DE)

(21) Appl. No.: 19/302,181

(22) Filed: Aug. 18, 2025

(30) Foreign Application Priority Data
Aug. 19, 2024 (DE) 202024104680.3

(51) Int. Cl. G06F 16/9535; G06F 3/01; G06F 3/041; G06F 3/16; G10L 13/00

(52) U.S. Cl. CPC G06F 16/9535; G06F 3/016; G06F 3/0412; G06F 3/167; G10L 13/00

(57) ABSTRACT

A user-specific electronic consumer appliance, in particular a consumer appliance adapted to the user's age, serves for the acoustic and/or optical and/or haptic reproduction of content generated using a generative model based on artificial intelligence. The generated content is adapted to the user, is generated using the generative model on the basis of a user-specific template, and the user-specific template contains a user preference assigned to the user profile and the user age.

### FIELD OF THE INVENTION

The present invention relates to a user-specific electronic appliance for displaying or otherwise outputting content. In particular, this invention concerns a user-specific electronic consumer appliance capable of outputting audible or visible content.

### BACKGROUND OF THE INVENTION

Such electronic consumer appliances and devices for displaying or otherwise outputting content are generally known in practice, such as tablets for displaying image, video, or text content. It is also known to adapt an electronic consumer appliance to the needs of the user. User-specific electronic consumer appliances for displaying or otherwise outputting content include, for example, stuffed animals with electronic playback functions for small children or personalized tablets for reproducing content on a display. These user-specific devices access the media commonly known in practice (e.g., from the Internet) in order to be used as entertainment devices for the user.

Content creation, especially in the media industry, has always been an essential part of the entertainment industry. Content creation using generative artificial intelligence is becoming increasingly important. The use of generative AI to generate content instantly and in large quantities enables content to be created in a particularly fast and efficient manner that can be personalized for different target groups and purposes.

This principle of using generative artificial intelligence is described, for example, in US 2024/0129601. This patent publication describes a method of generating content using a generative model. The content generated by the generative model is assigned to a user profile so that the content is generated by the user preferences in the user profile. In addition, a device for displaying the content is described.

Content generated using a generative model is usually reproduced on consumer appliances known in practice, such as computers, tablets, or smart phones. Individualization of the consumer appliance to the user is not applied in the prior art.

### OBJECT OF THE INVENTION

The object of the invention is to further develop such an electronic consumer appliance in order to provide a consumer appliance adapted to the user.

### SUMMARY OF THE INVENTION

To attain this object, the invention provides a user-specific electronic consumer appliance, in particular a consumer appliance adapted to the user's age, for the acoustic and/or optical and/or haptic reproduction of content generated using a generative model based on artificial intelligence. This generated content is adapted to the user, the content is generated using the generative model based on a user-specific template, and the user-specific template contains a user preference assigned to the user profile and the user age.

According to the invention, the term “generative model based on artificial intelligence” refers in the broadest sense to a content-generating and at least partially self-learning model that generates content in real time. According to the invention, the use of so-called large language models (LLM) is employed, among other things, but not exclusively. This type of artificial intelligence ensures that the content displayed or reproduced by the invention can be generated in real time and, in theory, continued indefinitely. These so-called large language models are usually computer linguistic-probability models that have learned statistical word and sentence sequence relationships from a large number of text documents through prior training processes. These can generate and output corresponding content in theoretically infinite lengths.

The content to be reproduced includes, for example, texts, images, videos, audio content, and combinations of the aforementioned examples.

According to the invention, the content is generated using the generative model based on a user-specific template. This user-specific template contains user preferences assigned to the user profile and the user's age. Additional characteristics can also be integrated into the user profile, such as gender, character traits, or moods. The invention works, for example, such that the user enters their age and a user preference, such as a preference for animal stories, into the user profile. This user profile is then made available to the generative model in the form of a user-specific template, and the user-specific template may contain additional user-related data, e.g., factory-set data, in addition to the user profile. It is also conceivable that the user profile contains a usage history or playback history and continuously supplements this. Furthermore, it is possible for the user to store user feedback on the generated content in the user profile during use. Furthermore, the user profile is preferably designed such that, with continued use and, if necessary, depending on the generated content and the feedback provided, the user profile is automatically adapted to the preferences of the user.

The generated content preferably includes user-specific stories, in particular narrative stories. Educational stories and, for example, stories that promote memory retention for older users are also conceivable. Stories, in particular narrative stories, are to be understood as a literary form that describes a coherent, self-contained plot. The plot described can be complete or open-ended. As a rule, a generated story has a clear structure with an introduction, a main part, and a conclusion. Narrative stories introduce characters, describe an initial situation, present conflicts or challenges, and, if applicable, present a solution or an end to the story. Invented stories can contain both realistic and fictional elements and convey values using specific themes, moral concepts, or human experiences. The narrative style of inventive stories can vary, from a first-person narrator who tells the story from their own perspective to an omniscient narrator who describes the events from a higher perspective. The invention works particularly well in that the user-specific requirements, together with the user preferences assigned to the user profile and the user's age, ensure that preferred themes and/or characters can be adapted to the user and implemented in the story.

The invention works best when the stories generated are specifically tailored to the user's age and follow user age-specific framework parameters, such as those defined on the device. According to the invention, the user age represents the most relevant framework parameter for the content to be generated and defines a large part of the story to be told. For example, a certain user age, e.g., under 16, results in adult content and topics being excluded. In principle, these framework parameters are not to be understood as static parameters, but as dynamic parameters that can change over time. The language model is tailored to the user, with the narrative style and language complexity adapted to the user's age. A device suitable for small children, for example, where the user age is already preset on the device or integrated into the user profile, selects a simple narrative style. The complexity of the story and/or language is adjusted depending on the user age, which is preferably preset on the device.

Furthermore, the device is preferably designed so that the user-specific content can be influenced by the user during playback via user input. The user input can take place in various ways, for example via voice input, key input, or via an external medium. The ability to influence user-specific content during playback makes it particularly advantageous to intervene directly in the content or story progression. For example, the user can change the main character after the story has begun. The generative model is able to adapt the story progression immediately after user input to meet the requirements at that point. The possibility of restarting a story that has already been partially or fully completed through user input, but with changes influenced by the user input, is also included. The invention also includes the possibility for the user to attach a user input, a save request, and/or a marker, such as a favorite marker, to the completed story after it has been finished, so that the story can be referenced at a later point in time. User input, where, for example, the main protagonist of an already completed story is to be replaced, can then be processed again at a later point in time with the changes made in accordance with the user input.

The user profile mentioned above gives preference to exclusion criteria. These criteria are already integrated into the user profile, at least in part, based on the user's age. Additional exclusion criteria can be added manually by the user, for example by entering them on the consumer appliance. The content generated by the generative model subsequently takes the added exclusion criteria into account. For example, a user with a specific phobia of animals and/or topics can enter these as exclusion criteria in the user preferences to ensure that the generated content or story does not deal with these animals or topics. User age-specific exclusion criteria are preferably preset on the consumer appliance, for example, the exclusion of adult content for consumer appliances that target a minor user group.

Preferably, the device is configured such that user preferences are based on a questionnaire-based definition of framework parameters. This questionnaire-based definition preferably includes topics, literary genres such as crime or fantasy, favorite authors, favorite animals and colors, favorite music, etc. Based on these user preferences, a user profile is created that contains the user's age as an additional framework parameter that in turn is entered into the user-specific template on the basis of which the generative model generates the content. It is advantageous if the questionnaire used to define the framework parameters is also AI-generated. It is also conceivable that the questionnaire can be customized by the user while filling it out. For example, as soon as the user expresses a preference for a particular topic in the questionnaire, AI-generated subquestions or subtopics relating to the user's preferred subject area can be created and queried. This is a particularly advantageous way of providing detailed user preferences with specific framework parameters.

The consumer appliance preferably has a user-specific form. Form in the sense of the invention refers in the broadest sense to physical characteristics and/or distinguishing features with recognition values that are adapted in particular to the age of the user.

The user-specific form preferably includes avatars and/or animals and/or color accents. The user-specific forms are preferably based on the user's age. Avatars as form refer, for example, to figures such as astronauts, doctors, soccer players, etc. Forms such as animals can be different animal species, in particular stuffed animals or similar animal species. The user-specific forms are preferably designed as forms that are at least partially integrated into the consumer appliance. This also includes forms that represent the entire consumer appliance.

Furthermore, the consumer appliance preferably has a user-specific touch interface. The user-specific touch interface is largely based on the user's age. In one embodiment, the touch interface is variable in size and complexity. A touch interface suitable for small children may, for example, be a simple layout with a few easy-to-use keys. A consumer appliance with a touch interface for adults, on the other hand, may be more complex and have comparatively more setting options. Sensors for controlling the consumer appliance, for example by gestures or movements on the part of the user, are also included in the invention.

The generated content is preferably reproduced as optical content, for example via a display and/or LEDs. Such a display is particularly preferred in a central position. Optical content reproduction in the form of LED light signals can, for example, take place on the outside of the consumer appliance. Optical content reproduction via a display in combination with LEDs is preferably coordinated with the content reproduction.

Furthermore, haptic reproduction is preferably carried out via vibrations and/or movements on the part of the consumer appliance. The movements on the part of the consumer appliance can, for example, be movements of a consumer appliance designed as a stuffed animal, whereby, for example, certain body parts are moved. The haptic reproduction advantageously ensures that the user experiences content reproduction that is as stimulating as possible to the user.

According to the invention, the consumer appliance is designed such that the acoustic reproduction of the content is preferably outputted as speech, for example via at least one loudspeaker. The voice output preferably generated takes into account the respective user-specific template, so that the user's age is also taken into account in the voice output. The voice output generated taking into account the user-specific template can preferably be in the form of a voice and optionally as a voice imitation. Voice imitations of, for example, dubbing actors or other public figures are conceivable. Furthermore, additional acoustic content appropriate to the content can be reproduced, for example, sounds such as animal noises, engine noises, or similar. The loudspeakers performing the acoustic reproduction are preferably located centrally on the consumer appliance. Several loudspeakers located on the outside are also conceivable.

Input from the user is preferably in the form of voice input, for example using a microphone. The microphone is preferably located centrally on the consumer appliance, but may also be located on the outside and in multiple versions. Voice input from the user can take the form of commands or whole sentences, for example. Voice input preferably includes the option of AI-based speech recognition.

Furthermore, according to the invention, the consumer appliance is designed such that the content is reproduced within a framework specified by the user, in particular a time frame. The time frame can be entered into the user profile or specified as a voice input before the content is generated. The time frame is particularly important in relation to narrative stories as content to be outputted, as it defines the length of the story and thus the speed at which it is narrated.

A remote control that can be connected to the consumer appliance and is capable of generating the user-specific template and transferring it to the consumer appliance is preferred. The invention also includes the generation and editing of the user-specific template on the consumer appliance. The connectable remote control is preferably designed as a smart phone or tablet. The connection between the consumer appliance and the remote control is preferably established via Wi-Fi and/or Bluetooth or generally wirelessly. With the aid of the remote control, external operation by, for example, a parent or guardian with access to the user profile is possible. Internal operation is of course also included. In this way, it is particularly easy and quick to respond to content output without having to directly control the consumer appliance itself. Furthermore, any changes to the user profile can be made in a simple and clear manner.

Preferably, the consumer appliance is capable of storing user-specific data on the consumer appliance and/or on the remote control, whereby the data can optionally influence the content output. User-specific data within the meaning of the invention refers, for example, to photos, self-created images and/or works, own literary works or data relating to the user himself. Storage on the consumer appliance and/or on the remote control can, for example, be an upload process via Wi-Fi and/or Bluetooth and subsequent storage directly on the consumer appliance, on the user's device, and/or on the remote control. Cloud storage is also included in the invention for this data and/or the digital components of the invention. For example, the consumer appliance can optionally integrate the uploaded user-specific data at least party into the user profile in order to create a story relating to the souvenir photos, for example, based on the user-specific template. Direct communication between the consumer appliance and the cloud storage and the generative model operating thereon is also included.

### BRIEF DESCRIPTION OF THE DRAWING

The invention is explained in more detail below with reference to drawings, in which:

FIG. 1 shows a consumer appliance according to the invention in the form of a teddy bear with speaker output and internal device controller;

FIG. 2 shows a consumer appliance in the form of an animal with a centrally located display;

FIG. 3 shows a consumer appliance in the form of a tablet with large buttons; and

FIG. 4 is a schematic view of user-specific adaptations.

### SPECIFIC DESCRIPTION OF THE INVENTION

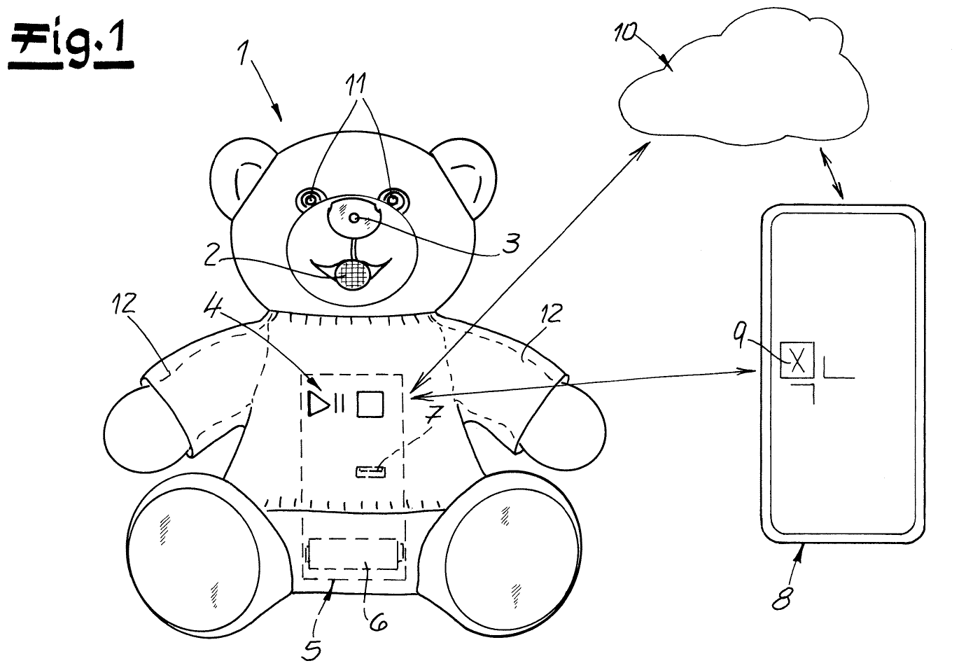

FIG. 1 shows a consumer appliance 1 according to the invention in the form of a plush teddy bear although of course other types of toys are possible. This embodiment of the consumer appliance 1 is suitable, for example, for small children under two years of age. The teddy bear 1 has a loudspeaker 2 located in the mouth of the teddy bear for outputting audio content. Also located on the head, and in this example in the nose of the teddy bear, is a microphone 3 suitable for voice input. In addition to voice input, a minimal keyboard 4 is also provided centrally on the belly of the teddy bear. For particularly easy operation, only three buttons are provided, namely play, pause, and stop. Furthermore, the teddy bear 1 holds a device controller 5 in the belly area, which is only shown in dashed lines here. The device controller 5 is designed so that it can be powered by, for example, a simple battery 6. The device controller 5 is equipped with an opening on the back of the teddy bear, for example for replacing the battery. In addition, the device controller 5 has an interface 7, for example a USB jack. Furthermore, the device controller 5 is connectable to a remote control 8. The remote control 8 is designed here as a smart phone. In the example shown in FIG. 1, the connection is established wirelessly using a Wi-Fi connection.

The process for generating a story and/or educational story is as follows. First, a user profile 17 is created via an app 9 installed in the remote control 8. To do this, a questionnaire is first filled out by a parent or guardian in the app 9. The questionnaire is specifically designed to cover topics that are interesting for young children under the age of two. As an example, the interests of the user or here the child are determined such as for instance if the child likes stories about rabbits. Based on this questionnaire, a user preference 16 is now defined. The user preference 16 and the user age 15, which is also entered in app 9, together form the user profile 17. This user profile 17 is transferred from the smart phone 8 to the device controller 5 where it forms the user-specific template 18 for the generative model. The user-specific template 18 now specifies that the child, with a user age of 15, prefers stories about rabbits in particular. As a result, a story is generated by the generative model based on this user-specific template 18. This can be done, for example, by the child using the microphone 3 to say something like “Tell me a story” or by pressing the play button on the keypad 4.

The user profile 17 may already contain preset preferences depending on the physical forms of the consumer appliance. In the specific example, this means that a teddy bear consumer appliance 1 already prefers to output stories involving teddy bears. It is also conceivable, for example, that the form of the consumer appliance 1, in this case the teddy bear, acts as the narrator and tells an educational story, for example. This example presetting is, of course, optional and can be deactivated.

The device controller 5 uses a generative model based on artificial intelligence to create the story. Here, the device controller 5 has sufficient computing power for generating the story, which is accomplished with the help of a cloud server 10. The device controller 5 communicates with cloud server 10 using the existing Wi-Fi connection and generates the required story there. This is then transmitted to the device controller 5 and/or remote control 8. The output is then delivered by the consumer appliance 1 via the loudspeaker 3 with virtually no delay.

In addition to audio output via speaker 2, it is also planned that supplementary visual outputs will be provided in connection with the story. This will be done via eye LEDs 11 and in coordination with the content of the story.

In addition, it is planned that the teddy bear 1 can perform movements, such as movements of its arms 12, also in conjunction with and depending on the content of the story. It is conceivable, for example, that if the story is about a running rabbit, the teddy bear will flash its LED eyes 1 quickly and/or move its arms 12 quickly and briefly.

If the parent or guardian finds a story about a running rabbit too disturbing, they can use the app 9 to influence the subsequent narration by entering a command such as “Story should be calmer.” The input is transmitted to the cloud server 10 via the smart phone 8, so that the generative model adapts the story line based on this input to make the narrative style calmer overall. This adjustment is transmitted to the device controller 5 with virtually no delay, and the story is then played back via the loudspeaker 2 in a calmer and/or, if necessary, quieter manner.

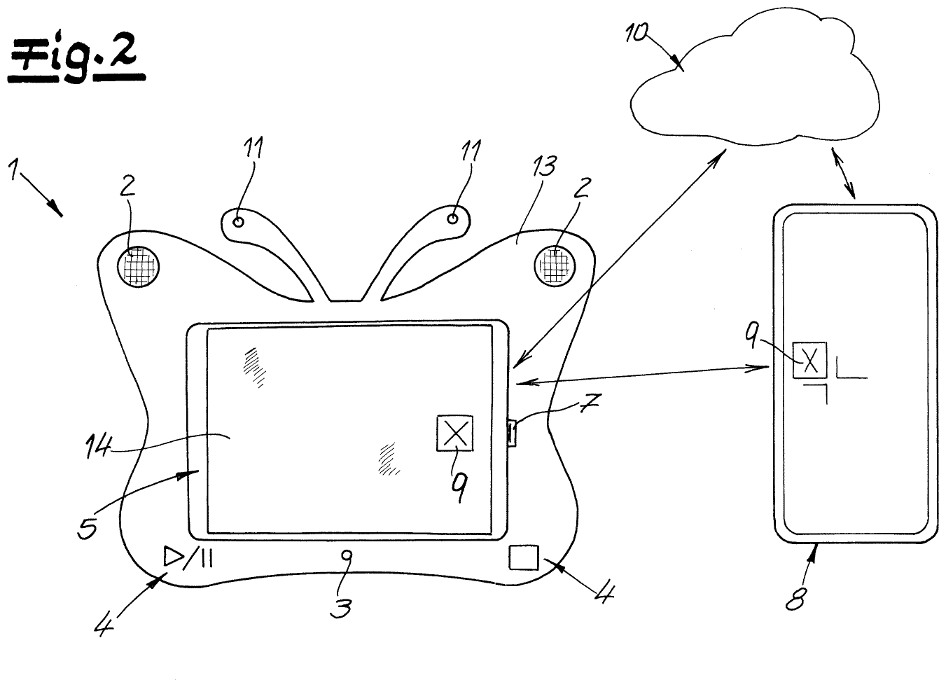

FIG. 2 shows a consumer appliance according to the invention, here in particular for infants, for example at most six years old. In the broadest sense, the consumer appliance consists of two main components. On the one hand, there is the device controller 5 in the form of a tablet that makes up the largest part of the consumer appliance. In addition, the consumer appliance 1 has a user-specific form, in this case in particular plastic extensions in the form of a butterfly 13. The device controller 5 is equipped with a display, in particular a touch screen 14.

Similar to the previous descriptions relating to FIG. 1, the consumer appliance 1 in FIG. 2 also works with a generative model based on artificial intelligence running on a cloud server 10, whereby commands and/or changes can be transmitted to the generative model using both the consumer appliance 1 and the remote control 8.

The tablet 1 has two speakers 2 located on each side and a microphone 3 also located on the outside for audio output and voice input, respectively. The battery-powered tablet 1 has an interface 7, in particular a USB interface 7, for charging and/or data transfer.

In addition to the option of input via the touchscreen 5, the tablet 1 also has a simple touch interface 4. This is advantageous because it allows the content output to be started, paused, and stopped even when the display 14 is locked.

The display 14 makes it possible to not only use acoustic and visual accents in addition to the generated story already described in connection with FIG. 1, but also to use the display 14 to play back video or image content. It is intended that, in addition to the generated story adapted to the user's wishes, the generative model can also display for example, comic-like image sequences in accordance with the generated story.

Returning to the example of the rabbit story mentioned in relation to FIG. 1, this means that in addition to the generated story output via the loudspeakers 2 the tablet 1 also presents image sequences on the display 14 that are coordinated with the generated story.

Furthermore, the tablet 1 is equipped with a vibration function to enable haptic feedback in addition to the visual and acoustic content playback.

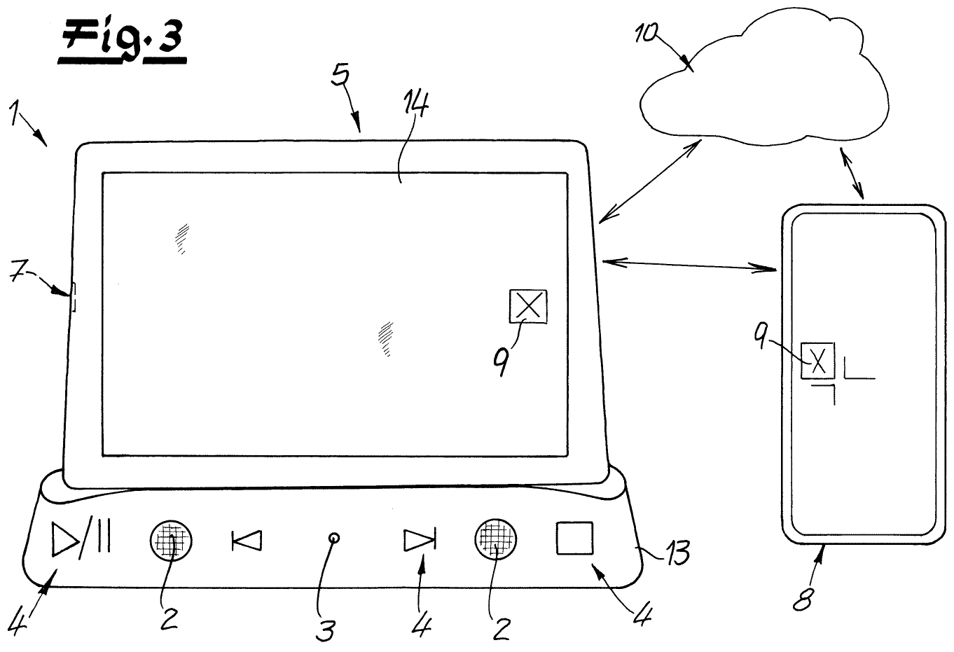

FIG. 3 shows a consumer appliance 1 that is designed especially for older users, such as seniors. The consumer appliance 1 has a tablet-shaped device controller 5 with a display 14 and a base 13. The base 13, which is designed for seniors, is a simple multimedia panel with buttons 4, a speaker 2, and a microphone 3, all on the outside of the tablet 1 which is of plastic and/or metal. In addition, the appliance 1 has an interface 7, in particular a USB interface 7 that is suitable for charging and/or data transfer.

The consumer appliance 1 described in this case, which is particularly suitable for senior citizens, is characterized in that the content output is based on the user's own data. In the specific example, this means that the user and/or a second user, such as a family member or relative, integrates user-specific data into the user profile either directly via the interface 7 or indirectly using the remote control 8. Personal data can include mementos such as photos, location of residence, occupation, partners, or other life events. The data is integrated, for example, by the user entering their own souvenir photos into the user profile 17 using the app 9 on their smart phone 8 or the device remote control 5. These souvenir photos are then integrated into the user-specific template 18 in the cloud server 10 and uploaded to the cloud server 10. The user profile 17 with the uploaded souvenir photos is also simultaneously transferred to the consumer appliance 1 and updated.

On the one hand, this makes it possible to play back these reminder photos on command and thus use the consumer appliance 1 as a kind of digital picture frame. On the other hand, the generative model can now be used to create a generated story based on the uploaded reminder photos.

If a subfolder is created in the user profile 17 with, for example, grouped vacation photos from a specific vacation, the user can subsequently refer to the subfolder name to generate a generated story could be based solely on these images. The generative model based on artificial intelligence is then able to analyze the uploaded images such that a story in narrative format can be outputted based on the motifs and events recognized there.

Furthermore, user-related data can be used to generate retrospective stories to strengthen the user's own memory. Educational stories for acquiring basic skills and knowledge, for example for people with dementia, are also conceivable.

In addition to the acoustic playback of the generated story, tablet 1 displays the memory photos corresponding to the generated story on display 14 and/or additionally generated images or videos based on the uploaded memory photos.

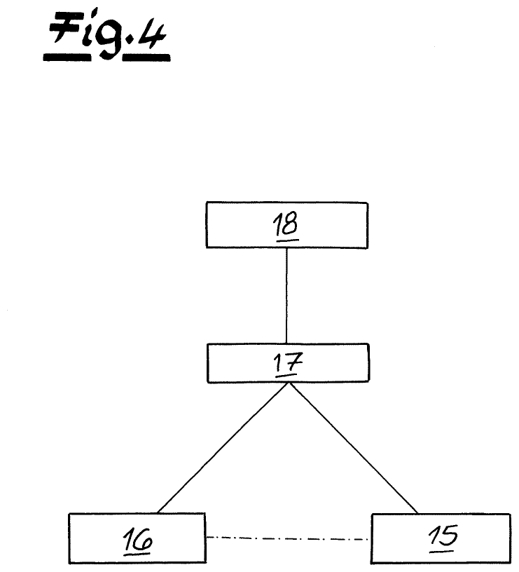

FIG. 4 schematically shows the structure of the various hierarchies, in particular with regard to the information used to generate the content. According to the invention, the input of information by the user is designed such that the user preference 16 is first determined. As already explained in FIG. 2, this is done, for example, using a questionnaire. The user age 15 is already defined in the consumer appliance 1, at least in an age range, but can be adjusted by the user at a later stage. This serves, for example, to prevent the output of content that is not suitable for users of the specific user age.

The user age 15 specified on the consumer appliance, in combination with the user preference 16, forms the user profile 17. The user profile 17 may also contain user-specific data, such as reminder photos that can be entered via the app 9. The user profile 17 is stored on the consumer appliance, on the cloud server 10, and, if applicable, on the remote control 8, and is continuously updated. Based on the user profile 17, a user-specific template 18 suitable for the generative model is then created, which is ultimately used as the basis for the generated content.

1. A user-specific electronic consumer appliance adapted to the user's age, for acoustic and/or optical and/or haptic reproduction of content generated using a generative model based on artificial intelligence, wherein
the generated content is adapted to the user;
the content is generated using the generative model based on a user-specific template;
the user-specific template contains a user preference assigned to the user profile and the user age.

2. The appliance according to claim 1, wherein the generated content comprises user-specific narrative stories and/or educational stories.

3. The appliance according to claim 2, wherein the stories are adapted to the user age and follow user age-specific framework parameters.

4. The appliance according to claim 1, wherein the user-specific content is variable by the user during playback by user input.

5. The appliance according to claim 1, wherein the user profile includes exclusion criteria.

6. The appliance according to claim 1, wherein the user preference is based on a questionnaire-based definition of framework parameters.

7. The appliance according to claim 1, wherein the consumer appliance has a user-specific form.

8. The appliance according to claim 7, wherein the user-specific form comprise avatars and/or animals and/or color accents.

9. The appliance according to claim 1, wherein the consumer appliance has a user-specific touch interface.

10. The appliance according to claim 1, wherein the optical content reproduction is carried out, for example, via a display and/or LEDs.

11. The appliance according to claim 1, wherein the haptic reproduction is effected by vibrations and/or movements of the appliance.

12. The appliance according to claim 1, wherein the acoustic reproduction of the content takes place as voice output from at least one loudspeaker.

13. The appliance according to claim 1, wherein the input from the user is provided as voice input, for example by a microphone.

14. The appliance according to claim 1, wherein the content is reproduced within a framework specified by the user.

15. The appliance according to claim 1, further comprising;
a remote control couplable to the appliance and that generates the user-specific template and transfers it to the consumer appliance.

16. The appliance according to claim 1, wherein user-specific data is stored on the consumer appliance and/or on the remote control and the data influences the content output.
